(19) United States
(12) Patent Application Publication
(10) Pub. No.: US 2007/0188827 A1
(43) Pub. Date: Aug. 16, 2007

(54) SCANNER WITH LIMITED COVER ANGLE

(75) Inventor: Xian Jun Wang, Suzhou (CN)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/673,964

(22) Filed: Feb. 12, 2007

(30) Foreign Application Priority Data
Feb. 14, 2006 (TW) TW95104884

(51) Int. Cl. H04N 1/04

(52) U.S. Cl. 358/474; 358/505

(57) ABSTRACT

A scanner comprises a main body, a cover and a limiting mechanism. The cover is rotatably disposed on the main body to cover a scanned object. The limiting mechanism is disposed between the main body and the cover. When the main body is horizontal, the limiting mechanism does not function and the cover assures a workable angle. When the main body is erected, the limiting mechanism limits the cover to a predetermined angle.

### BACKGROUND OF THE INVENTION

1. Field of the Invention

The invention relates to a scanner, and in particular to a scanner with cover opened to a predetermined angle.

2. Description of the Related Art

Referring to FIG. 1a, a conventional scanner 10 comprises a main body 5 and a cover 7. The cover 7 can be opened to an angle α, exceeding 90° for easy operation, however, when erected or hung on a wall, as shown in FIGS. 1b and 1c, to avoid damage, the open angle of the cover 7 must be limited. In general, the open angle of the cover 7 is between 30° to 60° when the scanner 10 is erected.

### BRIEF SUMMARY OF THE INVENTION

An embodiment of a scanner of the invention comprises a main body, a cover and a limiting mechanism. The cover is rotatably disposed on the main body to cover a scanned object. The limiting mechanism is disposed between the main body and the cover. When the main body is horizontal, the limiting mechanism does not function and the cover can assure a workable angle. When the main body is erected, the limiting mechanism limits the cover to a predetermined angle.

The limiting mechanism comprises a first hook rotatably disposed on the main body and a second hook corresponding to the first hook and fixed to the cover. When the main body is horizontal, the first hook does not engage the second hook and the cover can assure a workable angle. When the main body is erected, the first hook engages the second hook and the cover is limited to the predetermined angle.

The main body has a inclined surface. When the main body is horizontal, the first hook leans on the inclined surface without engaging the second hook. When the main body is erected, the first hook rotates from the inclined surface by gravity to engage the second hook.

The first hook comprises a pivot portion rotatably disposed on the main body and a first hook portion connected to the pivot portion and engaging the second hook.

The pivot portion and the first hook portion can be formed integrally. In another aspect, the first hook portion can be rotatably connected to the pivot portion. The first hook further comprises an extension spring or a torsion spring connecting the first hook portion and the pivot portion, whereby the first hook portion is positioned to the pivot portion.

The first hook further comprises a rib disposed on the pivot portion and abutting the first hook portion, whereby the first hook portion is positioned to the pivot portion.

The main body has a through hole, and the pivot portion has a shaft joined to the through hole, whereby the pivot portion is rotatably disposed on the main body.

The shaft has a curved groove with a first end and a second end, and a protrusion disposed in the through hole such that when the shaft is joined to the through hole, the protrusion is in the curved groove. When the main body is horizontal, the protrusion abuts the first end, whereby the first hook does not engage the second hook. When the main body is erected, the first hook is rotated by gravity and the protrusion abuts the second end, whereby the first hook engages the second hook and the cover is opened to the predetermined angle.

The second hook comprises a support portion fixed to the cover and a second hook portion connected to the support portion and engaging the first hook.

The second hook portion and the support portion can be formed integrally. In another aspect, the second hook portion can be rotatably connected to the support portion. The second hook further comprises an extension spring or a torsion spring connecting the second hook portion and the support portion, whereby the second hook portion is positioned to the support portion.

The second hook further comprises a rib disposed on the support portion and abutting the second hook portion, whereby the second hook portion is positioned to the support portion.

### BRIEF DESCRIPTION OF THE DRAWINGS

The invention can be more fully understood by reading the subsequent detailed description and examples with references made to the accompanying drawings, wherein:

FIGS. 1a, 1b and 1c depict a conventional scanner;

FIG. 2 is a schematic view of an embodiment of a scanner of the invention;

FIG. 3 is an enlarged view of the limiting mechanism of FIG. 2;

FIGS. 4a˜4c depict motion of the limiting mechanism when the scanner is horizontal;

FIGS. 5a˜5d depict motion of the limiting mechanism when the scanner is erected;

FIGS. 6a and 6b depict another embodiment of a scanner of the invention;

FIGS. 7a and 7b depict another embodiment of a scanner of the invention;

FIGS. 8a˜8c are schematic views of the first hook and the second hook of the embodiment of FIGS. 7a and 7b;

FIG. 9 depicts another embodiment of a scanner of the invention;

FIG. 10 depicts another embodiment of a scanner of the invention; and

FIG. 11 depicts another embodiment of a scanner of the invention.

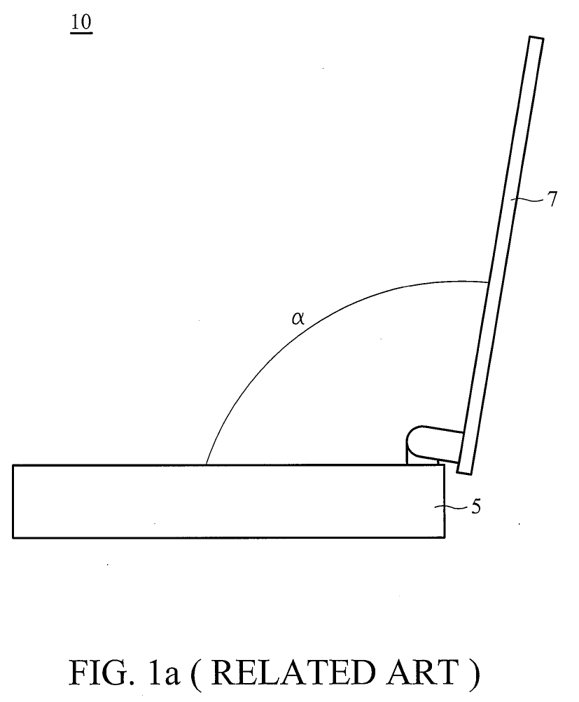

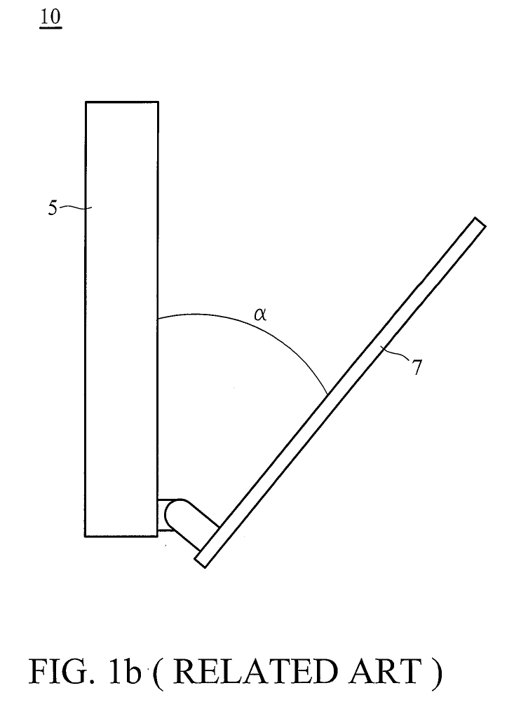

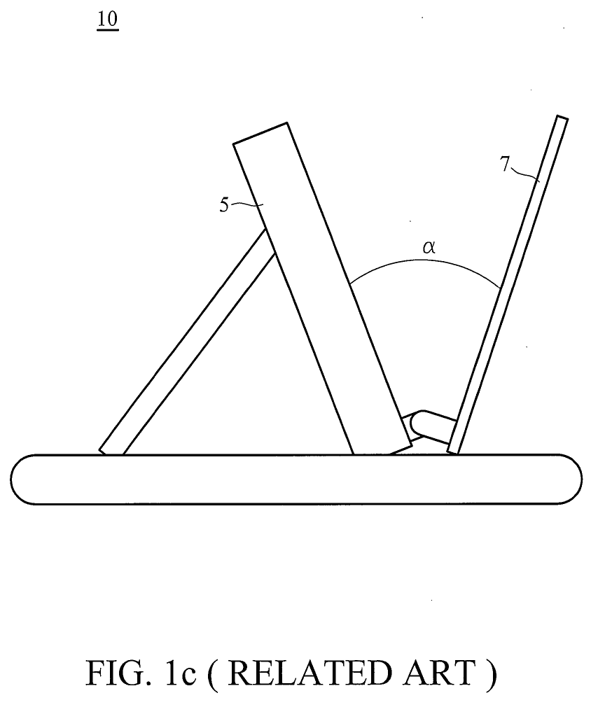

### DETAILED DESCRIPTION OF THE INVENTION

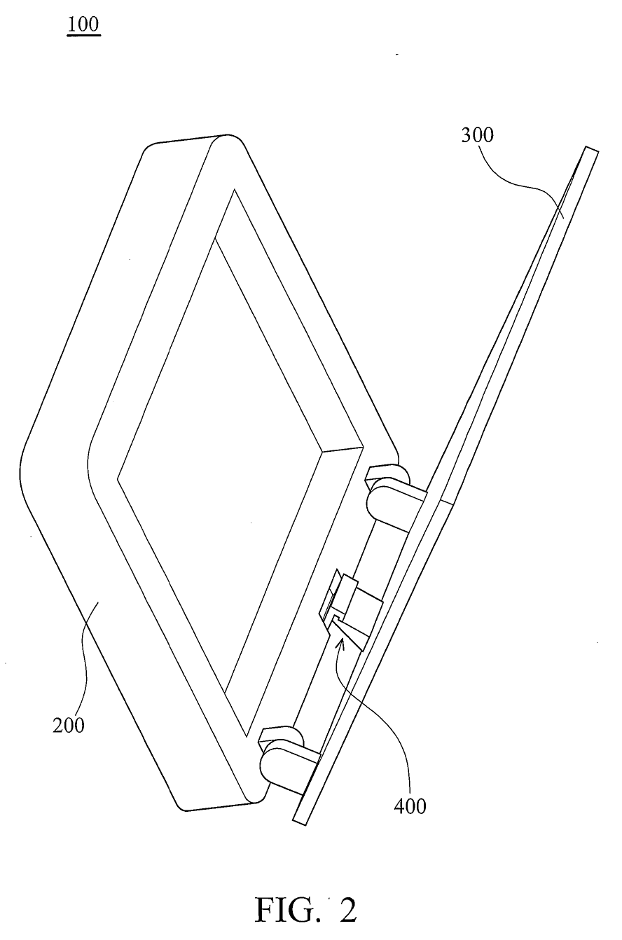

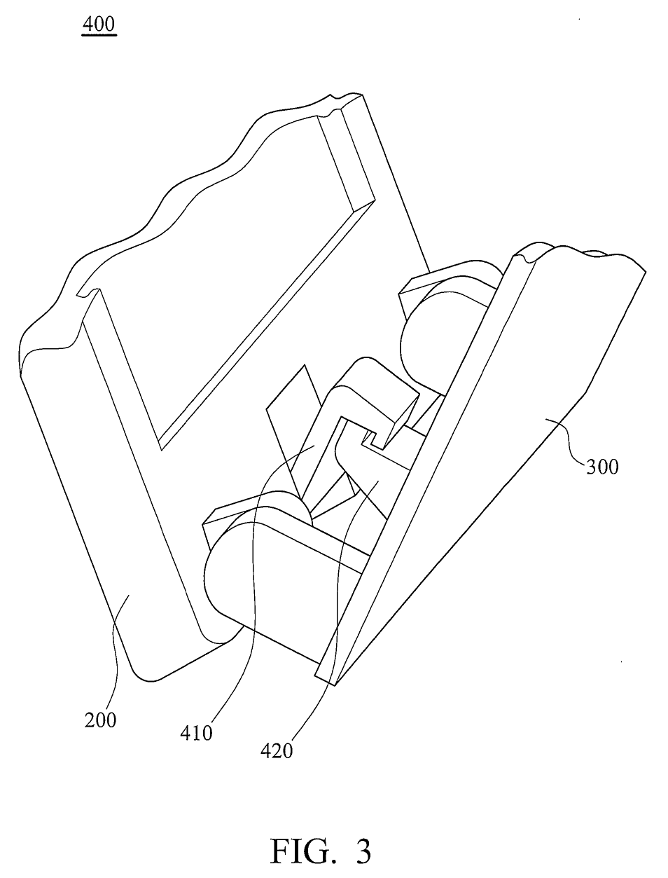

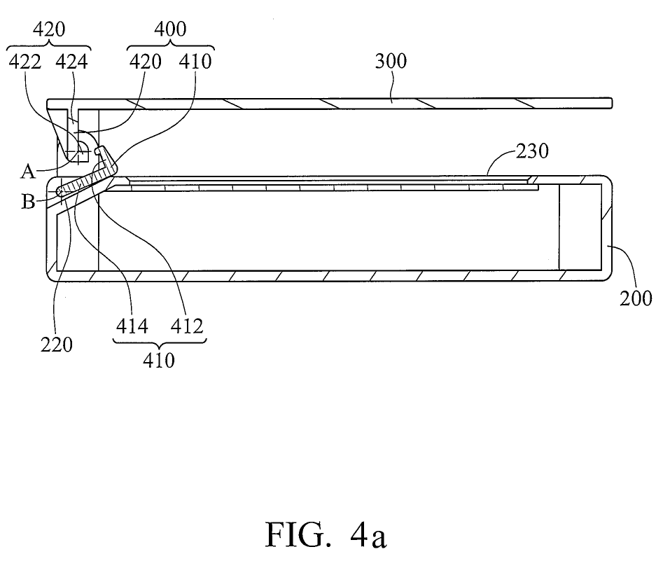

Referring to FIG. 2, a scanner 100 of the invention comprises a main body 200, a cover 300 and a limiting mechanism 400. FIG. 3 is an enlarged view of the limiting mechanism 400. The limiting mechanism 400 comprises a first hook 410 and a second hook 420. The first hook 410 is rotatably disposed on the main body 100. The second hook 420 is fixed to the cover 300. The first hook 410 and the second hook 420 are substantially L-shaped and capable of engaging each other. The first hook 410 comprises a first hook portion 412 and a pivot portion 414 rotatbly connected to the main body 200 with respect to a shaft B. The second hook 420 comprises a second hook portion 422 and a support portion 424 fixed to the cover 300. The second hook portion 422 is connected to the support portion 424. The first hook portion 412 and the second hook portion 422 engage each other.

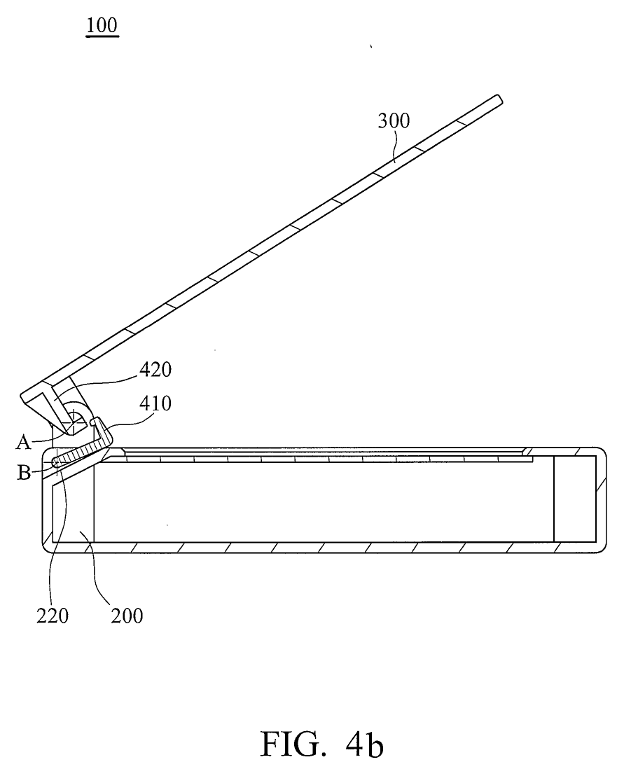

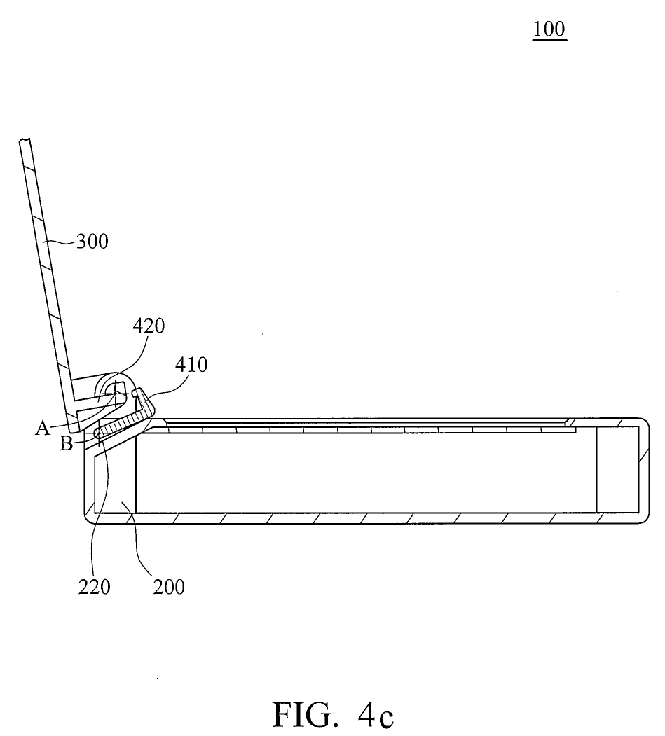

FIGS. 4a˜4c depict motions of the limiting mechanism 400 when the scanner 100 is horizontal. When the main body 200 is horizontal, the first hook 410 leans on an inclined surface 220 of the main body 200. The inclined surface 220 has a proper angle with respect to the scanning plane 230, whereby the first hook 410 cannot engage the second hook 420. When the cover 300 is rotated about a shaft A and lifted upward the first hook 410 cannot constrain the cover 300, whereby the cover 300 can be opened to an appropriate workable angle, as shown in FIGS. 4b and 4c.

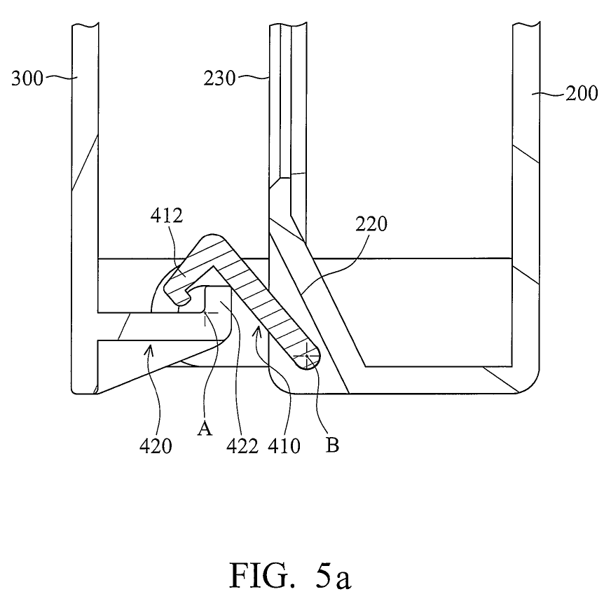

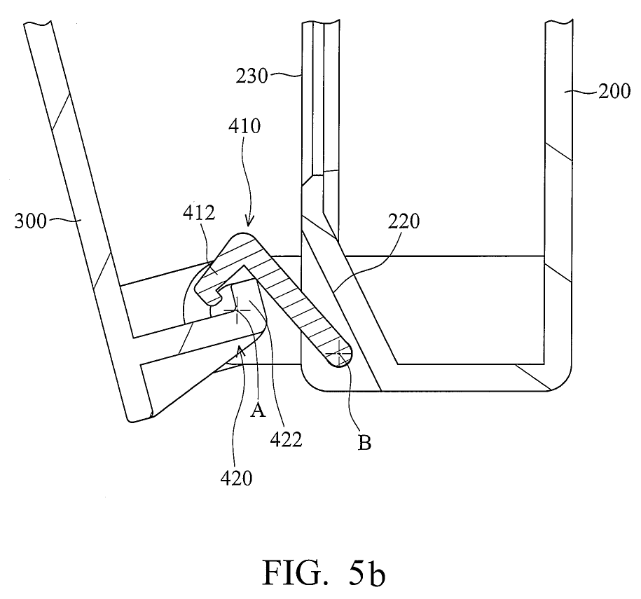

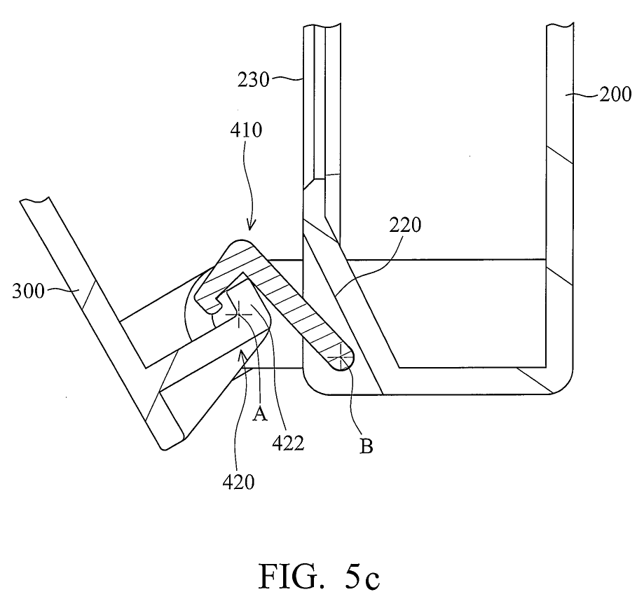

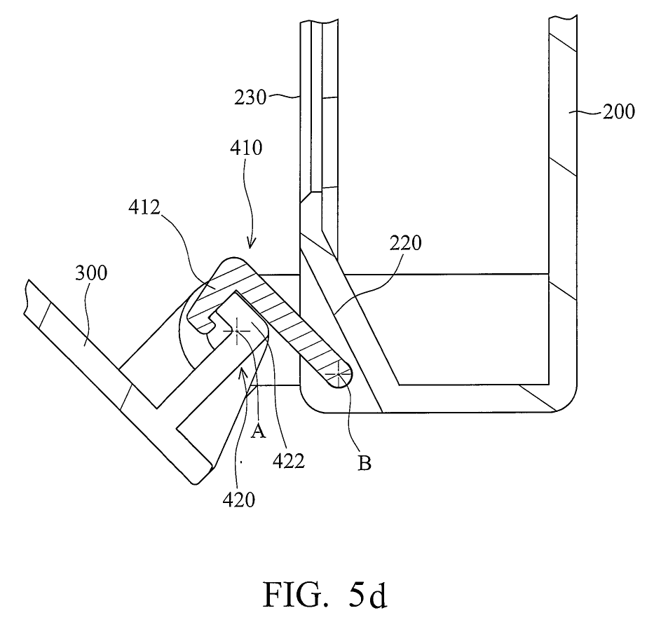

FIGS. 5a˜5d depict motion of the limiting mechanism 400 when the scanner 100 is erected. In FIG. 5a, when the main body 200 is erected, the first hook 410 is inclined by a proper angle with respect to a vertical plane due to the inclined surface 220. The first hook 410 is rotated by gravity to contact with the second hook portion 422. When the cover 300 is rotated about the shaft A and opened, the second hook portion 422 engages the first hook portion 412 to limit the open angle of the cover 300 as shown in FIGS. 5b˜5d.

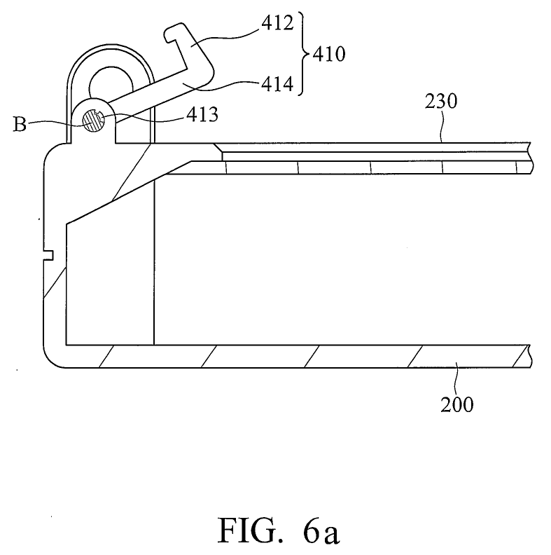

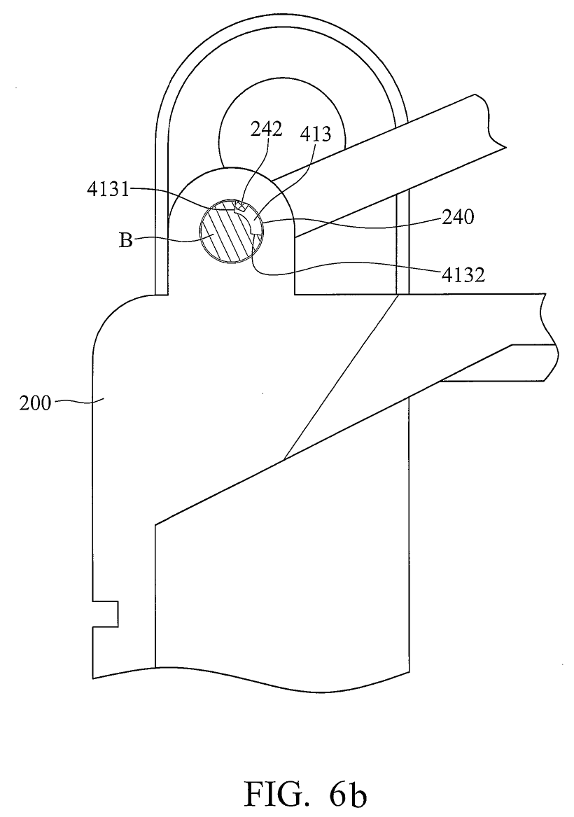

In the embodiment, when the main body 200 is erected, the angle of the inclined surface 220 with respect to the vertical plane (the scanning plane 230) ensures that the first hook 410 rotates to engage the second hook 420. FIGS. 6a and 6b depict another embodiment of a scanner of the invention. In this embodiment, a curved groove 413 is formed on the shaft B. The curved groove 413 has a first end 4131 and a second end 4132. The main body 200 has a through hole 240 in which a protrusion 242 is disposed. When the shaft B engages the through hole 240, the protrusion 242 is in the curved groove 413 and capable of abutting the first end 4131 or the second end 4132. When the main body 200 is horizontal, the first hook 410 is rotated clockwise by gravity. At this time, the first end 4131 abuts the protrusion 242, whereby the first hook 410 is inclined with respect to the scanning plane 230 as shown in FIG. 6a. When the main body 200 is erected, the first hook 410 is rotated counterclockwise by gravity and the second end 4132 abuts the protrusion 242, whereby the first hook 410 engages the second hook 420 and the cover 300 is opened to a predetermined angle.

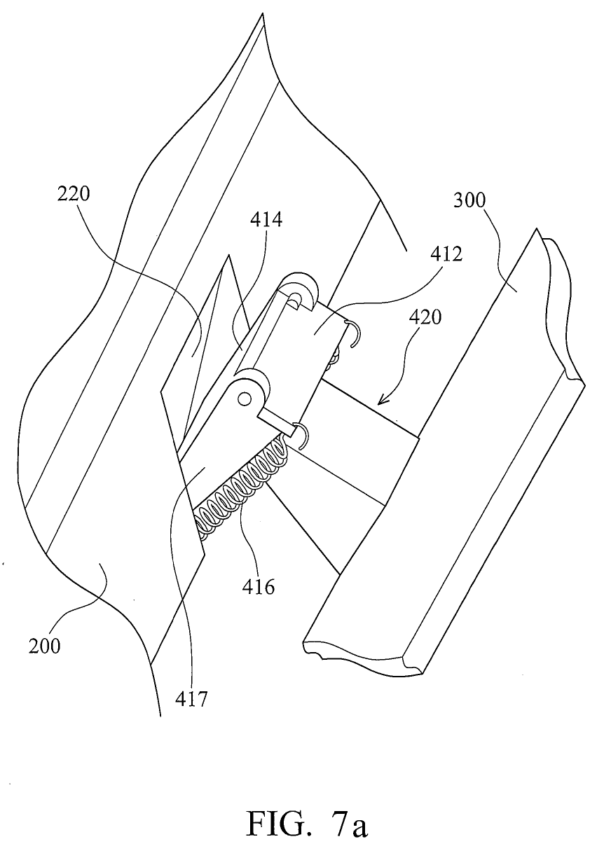

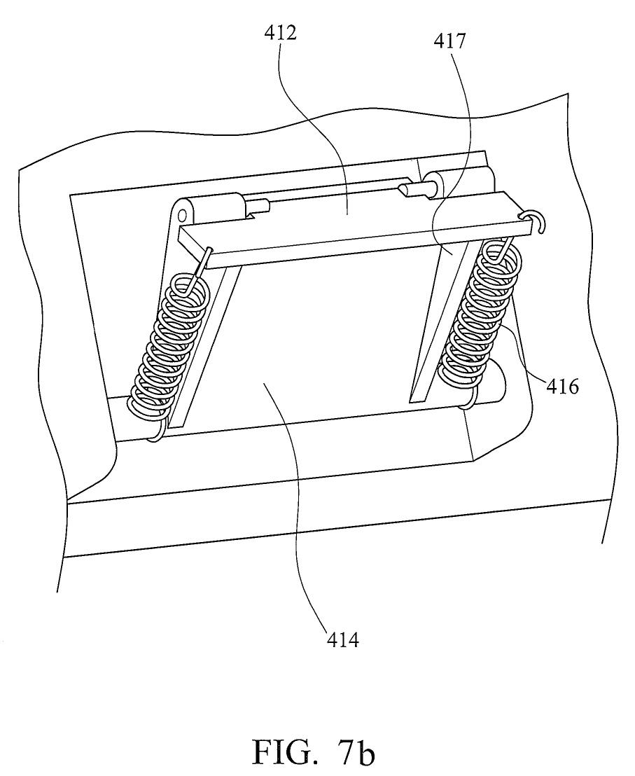

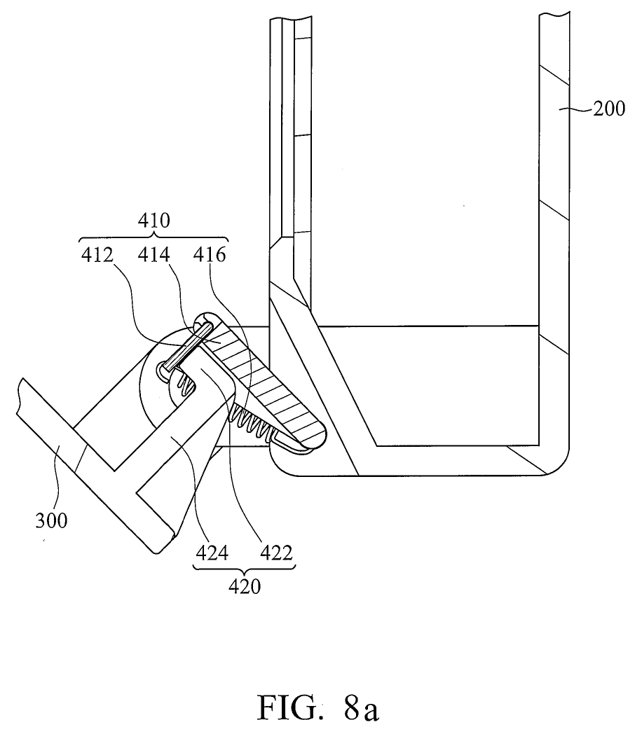

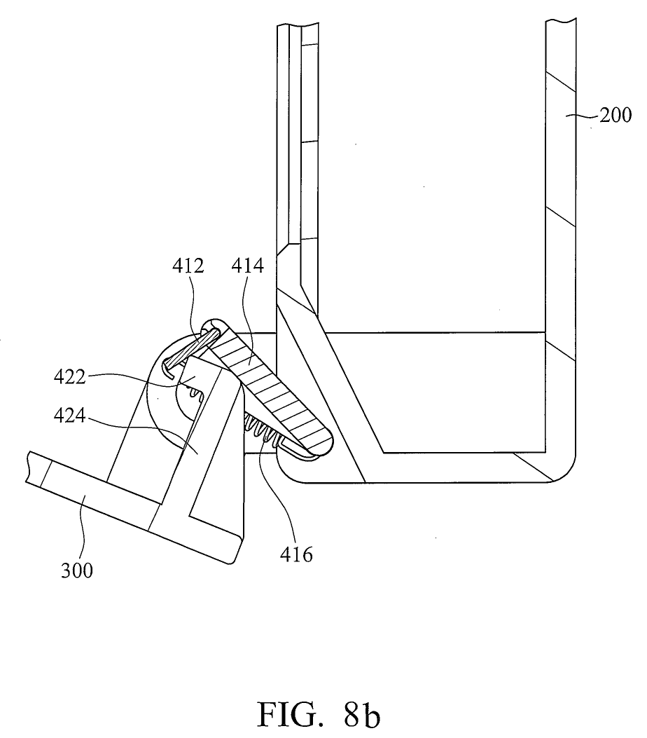

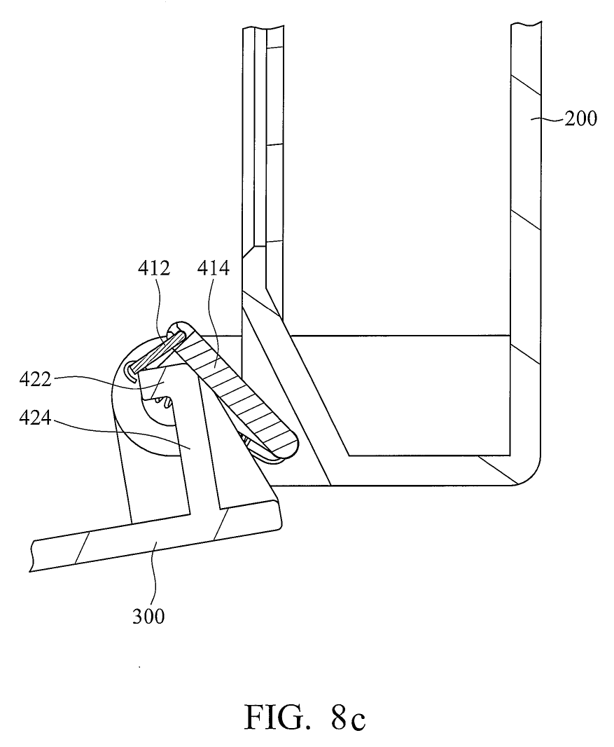

FIGS. 7a and 7b depict another embodiment of the invention. The embodiment is similar to the embodiment shown in FIG. 2. Only the first hook 410 is different from the previous embodiment. The first hook portion 412 is pivoted on the pivot portion 414, and an extension spring 416 connects the first hook portion 412 and shaft B. A pair of ribs 417 is disposed on the pivot portion 414 and abuts the first hook portion 412. When the extension spring 416 pulls the first hook portion 412, the first hook portion 412 abuts the rib 417 and is positioned to the pivot portion 414. FIGS. 8a˜8c depict the first hook 410 engaging the second hook 420 of the embodiment. FIG. 8a depicts the cover 300 opened to a maximum angle when the main body 200 is erected. If the cover 300 is further opened, the extension spring 416 is extended and the second hook portion 422 forces the first hook portion 412 to rotate with respect to the pivot portion 414, whereby the cover 300 is opened to a maximum angle as shown in FIGS. 8b and 8c. In this way, when force is exerted on the cover 300, damage to the limiting mechanism 400 is avoided.

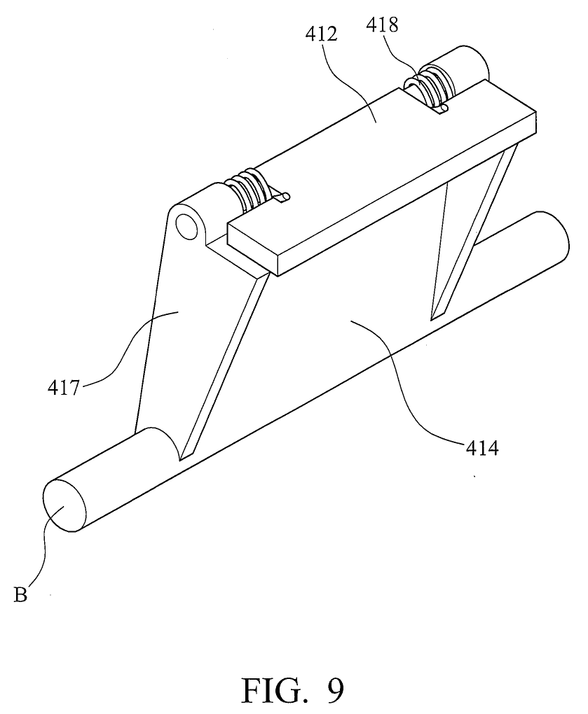

FIG. 9 depicts another embodiment of a scanner of the invention. The embodiment is similar to the embodiment shown in FIG. 7a. Only the extension spring 416 is replaced by a torsion spring 418. Operation of the embodiment is the same as the embodiment of FIG. 7a.

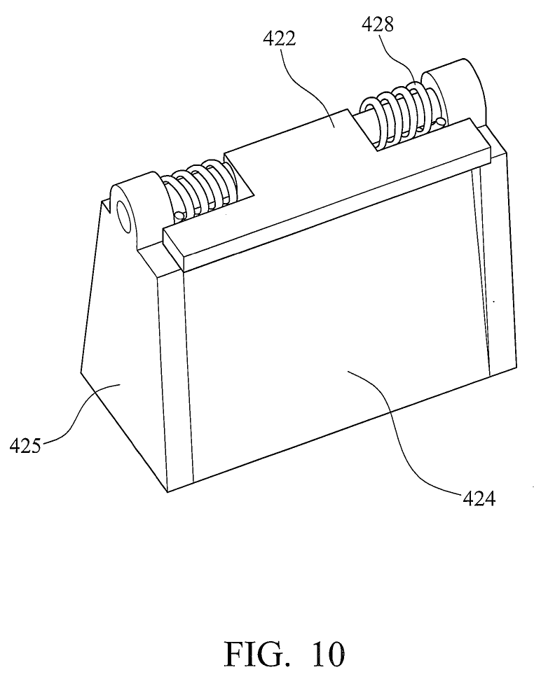

In the two embodiments, the first hook 410 comprises two individual elements, the first hook portion 412 and the pivot portion 414. Similarly, the second hook 420 can also comprise two individual elements. FIG. 10 depicts another embodiment of the invention. The second hook portion 422 is pivoted on the support portion 424. Two ribs 425 are disposed on opposite sides of support portion 424. A torsion spring 428 connects the second hook portion and the support portion 424. The second hook portion 422 abuts the rib 425 and is positioned to the support portion 424. As the motion of the embodiment is the same as the previous two embodiments, description is omitted.

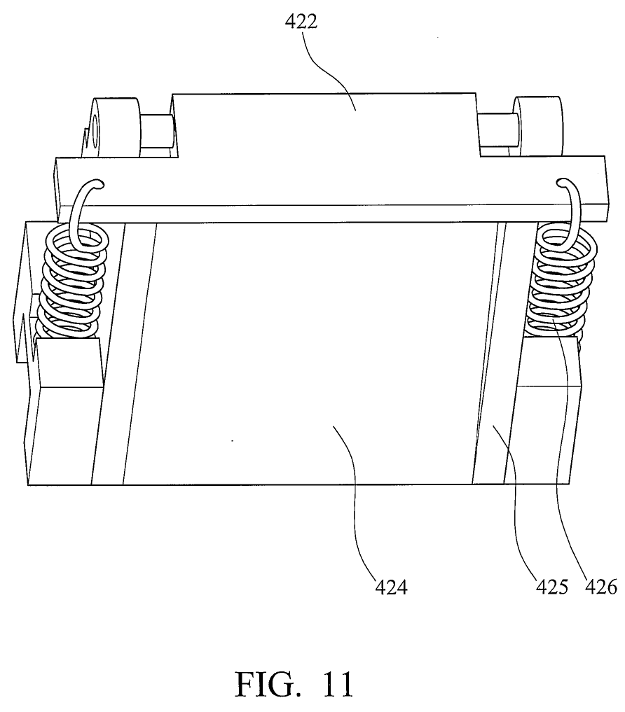

FIG. 11 depicts another embodiment of the invention. The embodiment is similar to the embodiment shown in FIG. 10. Only the torsion spring 428 is replaced by an extension spring 426 connecting the second hook portion 422 and the support portion 424.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scanner, comprising:
a main body;
a cover rotatably disposed on the main body to cover a scanned object; and
a limiting mechanism disposed between the main body and the cover, wherein when the main body is horizontal, the limiting mechanism does not function and the cover assures a workable angle, and when the main body is erected, the limiting mechanism limits the cover to a predetermined angle.

2. The scanner as claimed in claim 1, wherein the limiting mechanism comprises:
a first hook rotatably disposed on the main body;
a second hook corresponding to the first hook and fixed to the cover, wherein when the main body is horizontal, the first hook does not engage the second hook and the cover is opened to a workable angle, and when the main body is erected, the first hook engages the second hook and the cover is opened to the predetermined angle.

3. The scanner as claimed in claim 2, wherein the main body has an inclined surface, and when the main body is horizontal, the first hook leans on the inclined surface such that the first hook does not engage the second hook, and when the main body is erected, the first hook is rotated from the inclined surface by gravity to engage the second hook.

4. The scanner as claimed in claim 2, wherein the first hook comprises a pivot portion rotatably disposed on the main body and a first hook portion connected to the pivot portion and engaging the second hook.

5. The scanner as claimed in claim 4, wherein the pivot portion and the first hook portion are formed integrally.

6. The scanner as claimed in claim 4, wherein the first hook portion is rotatably connected to the pivot portion, and the first hook further comprises an extension spring connecting the first hook portion and the pivot portion, whereby the first hook portion is positioned to the pivot portion.

7. The scanner as claimed in claim 6, wherein the first hook further comprises a rib disposed on the pivot portion and abutting the first hook portion, whereby the first hook portion is positioned to the pivot portion.

8. The scanner as claimed in claim 4, wherein the first hook portion is rotatably connected to the pivot portion, and the first hook portion further comprises a torsion spring connecting the first hook portion and the pivot portion, whereby the first hook portion is positioned to the pivot portion.

9. The scanner as claimed in claim 8, wherein the first hook further comprises a rib disposed on the pivot portion and abutting the first hook portion, whereby the first hook portion is positioned to the pivot portion.

10. The scanner as claimed in claim 2, wherein the main body has a through hole, and the pivot portion has a shaft joined to the through hole, whereby the pivot is rotatably disposed on the main body.

11. The scanner as claimed in claim 10, wherein the shaft has a curved groove with a first end and a second end, and a protrusion is disposed in the through hole, such that when the shaft is joined to the through hole, the protrusion is in the curved groove.

12. The scanner as claimed in claim 11, wherein when the main body is horizontal, the protrusion abuts the first end, whereby the first hook does not engage the second hook, and when the main body is erected, the first hook is rotated by gravity and the protrusion abuts the second end, whereby the first hook engages the second hook and the cover is opened to the predetermined angle.

13. The scanner as claimed in claim 2, wherein the second hook comprises a support portion fixed to the cover and a second hook portion connected to the support portion and engaging the first hook.

14. The scanner as claimed in claim 13, wherein the second hook portion and the support portion are formed integrally.

15. The scanner as claimed in claim 13, wherein the second hook portion is rotatably connected to the support portion, and the second hook further comprises an extension spring connecting the second hook portion and the support portion, whereby the second hook portion is positioned to the support portion.

16. The scanner as claimed in claim 15, wherein the second hook further comprises a rib disposed on the support portion and abutting the second hook portion, whereby the second hook portion is positioned to the support portion.

17. The scanner as claimed in claim 13, wherein the second hook portion is rotatably connected to the support portion, and the second hook further comprises a torsion spring connecting the second hook portion and the support portion, whereby the second hook portion is positioned to the support portion.

18. The scanner as claimed in claim 17, wherein the second hook further comprises a rib disposed on the support portion and abutting the second hook portion, whereby the second hook portion is positioned to the support portion.
